(19) United States
(12) Patent Application Publication
(10) Pub. No.: US 2008/0235111 A1
(43) Pub. Date: Sep. 25, 2008

(54) Internet Art Community

(76) Inventors: Natan Dotan, Pelham, NY (US); Eliana Dotan, Pelham, NY (US)

Correspondence Address: Natan Dotan, 516 First Avenue, Pelham, NY, 10803, US

(21) Appl. No.: 11/690,133

(22) Filed: Mar. 23, 2007

(51) Int. Cl. G06F 17/30

(52) U.S. Cl. 705/27

(57) ABSTRACT

An internet-based system for making works of art accessible to a broad viewing public comprising a means whereby users may upload to an on-line database information describing individual works of art including information describing the accessibility of said works. Users may retrieve from said database information regarding artworks accessible in a specified location and time. Additionally users may upload information describing collections of artworks. Users may upload reviews of artworks and collections and also provide ratings of art works, of reviews, and of collections. Aggregated user ratings are visible by users of the system and thus serve several purposes including collaborative filtering and providing recognition of and reputation for individual artists, reviewers, collectors, artworks, reviews, and collections. Thus the present invention provides a means whereby artists, reviewers, collectors, and an interested public can interact without the intercession of limiting bodies.

In the United States and elsewhere public access to art is generally controlled by museums and art galleries. Access to art is generally limited by the visitation hours of these institutions. Furthermore the body of work seen by the public is controlled by curators and gallery owners who chose which pieces to purchase and display.

Artists who seek exposure for their works without the access constraints imposed by museums and galleries can create public art. Public art refers to art that is intentionally sited or staged in the public domain. Public art includes monuments, statues, and other works commissioned by governmental bodies. Although this form of art is often highly accessible—as viewing is limited by neither time or cost constraints—its production and presentation is controlled by the commissioning agency. Another form of public art is unsanctioned public art. This includes works that are generally not commissioned and installed without the sanction of governing authorities.

Unsanctioned public art is limited in several ways. Although it is highly accessible it is often ephemeral; it is often removed or destroyed after a period of time. This severely limits the scope of pieces that are suited for presentation as unsanctioned public. Oil paintings, for instance, would be destroyed by exposure to the elements if installed outdoors without further protection.

An additional form of art, which might be referred to as pseudo-public art, is art which is publicly displayed in commercial or private spaces. Such art may often be viewed at no cost to the viewer. For instance in the United States there are many coffee shops that display the art of local artists. A limitation of this type of presentation is that it often occurs in spaces that are not explicitly known as venues for the presentation of art. Thus even if such art is displayed, accessible, and freely available it may remain unknown to a broad potentially interested audience because information regarding its existence does not enter known channels for the publication and advertisement of art.

The limitations in the presentation of art described above result in an additional shortcoming in the present infrastructure for the production and distribution of art. This limitation lies in the fact that artists must often rely on traditional venues for presenting their art—e.g. museums and galleries. These venues often limit the art they exhibit based on the preferences and interests of their directors, curators, and owners. This can result in a limitation of experimentation and even a potential stifling of certain schools of practice. In this context if an artist chooses to present his/her art in non-traditional venues such as public spaces or in the form of pseudo-public art as described above then said artist risks failing to reach a sufficiently large and interested audience. Failing to reach a sufficiently large and interested audience is also threatening for an artist—peer responses to new works and reactions from art critics and analysts provide an important force for the development of an artists work. Thus an artist risks forgoing the advantages of working within the broader art community if he/she chooses to present his/her work outside of a given discipline's traditional venues.

### BACKGROUND OF THE INVENTION

### Description of Prior Art

A salient feature of the invention disclosed herein and which is lacking in the prior art, is the ability of a user to specify search criteria and be presented with information regarding what specific pieces of art are accessible in a given place and time. For example, the system disclosed herein answers the question of a user thinking to himself/herself: “It's 10:00 pm on Thursday night in Chicago and I want to see some art; where in Chicago can I go now and what can I see there?” Additionally, the invention provides a method for collaborative filtering, for providing recognition of, and for discussion of individual pieces of art (or more generally to artifacts).

Some attempts have been made to use the Internet in order to increase exposure for independent artists and to create a forum for discussion and presentation of their art. For instance the well-known Saatchi art gallery has a section on its web-site devoted to showcasing the art of students as well as providing a messaging feature whereby these students can interact (http://www.saatchi-gallery.co.uk/stuart/). This website also includes a feature whereby visitors can submit essays about contemporary art (http://www.saatchi-gallery.co.uk/contemporary-art/essays.htm). Users can also submit reviews of art exhibits or works, though not necessarily those works displayed on the web-site. Artists may also upload an “Artwork Description” to describe uploaded artworks. Additionally the website features a section called “Showdown” (http://www.saatchi-gallery.co.uk/showdown/PreviewArtworks.php) where works by various artists are presented and can be rated by users of the system. This rating scheme ends with a cash prize given to the highest rated works and with the highest rated work of art being exhibited in the Saatchi art gallery. It should be noted that in this voting scheme, a user can enter only one vote for each piece and can not change his/her vote after it has been entered.

While the Saatchi gallery website described above includes several valuable features it does have several shortcomings. Most severe of these shortcomings is the fact that the artworks represented on the website are presented as digital images and no information is provided regarding the accessibility of the original works. In the case of most art forms, a digital image of a work can give a viewer only a general sense of the work—the full effect of a work may only be experienced by viewing the original. Additionally, while the Saatchi gallery website includes a rating scheme described above in relation to the “showdown” feature, this scheme is limited. Ratings are used only to identify winners of a specific competition and aggregate ratings are not accessible by users of the site. Thus, a user accessing the site is not able to benefit from other users' opinions by preferentially viewing highly rated works and the rating scheme fails to serve collaborative filtering purposes.

An additional feature of the Saatchi gallery website is the possibility for museums to register on the website. Museums that register are able to post various forms of information, including cost, opening hours, location, as well as photographs of works and of the museum itself. Nevertheless, the Saatchi gallery website does not address the need to publicize and increase awareness of art exhibited in non-traditional venues (i.e. not museums or galleries). Additionally, although it does provide means for users to submit reviews, essays, and ratings, these are not all linked to records of the work referred to. Thus a user can not view aggregated responses of other users to a given work. Also, user responses are not used to preferentially display records regarding highly rated works—thus the potential for employing a system of collaborative filtering is missed. Another consequence of the fact that ratings and other user responses are not aggregated or linked to individual works is that outside of the “showdown” competition described above artists can not benefit from user responses to their works—either in the form of recognition or in the form of constructive criticism. The invention claimed herein solves these problems and facilitates the formation of a community involving both criticism and recognition for individual works as well as artists.

Several schemes exist in the prior art that take advantage of user-supplied information in order to make recommendations to other users. These schemes generally fall into a category known as “collaborative filtering.” Collaborative filtering schemes are employed by online services such as Amazon and YouTube. Several U.S. patents have been granted for such schemes. For instance U.S. Pat. No. 6,064,980 describes a system in which items are added to an online service when a sufficient number of user recommendations are made. Additionally, U.S. Pat. No. 5,790,426, U.S. Pat. No. 5,884,282, and U.S. Pat. No. 6,112,186 describe collaborative filtering schemes in which items are recommended to a first user based on similarity in the preferences of that user as compared with other users. These schemes rely on rating inputs from users.

While the voting and rating schemes described above do have merit on their own, as specified in the context of the invention disclosed herein, the inclusion of a rating scheme provides an unexpected added value. This lies in the fact that such a feature facilitates the openness and efficiency of an artistic community. The system disclosed herein is designed to provide a non-restrictive venue for the presentation of various works of art. In systems that must choose between openness and exclusivity there is generally a compromise between degree of openness and quality of content; that is, if all users are allowed to post information regarding their works on the system there will inevitably be users who post information that is of little interest or value to the majority of other users. Thus a mechanism is necessary for ensuring that users are not overwhelmed with information of no interest to them. Such information of no interest may include, for instance, information describing works of a poor-quality. At the same time it is highly desirable to implement such a mechanism without limiting the openness of the system described herein or restricting its use as a venue for the dissemination of information. Addition of a voting scheme provides another benefit in the context of the system disclosed herein in addition to creating a democratic system for promoting items of potentially greater interest to users without restricting use of the system. This additional benefit lies in the fact that user ratings can indicate popular recognition of a given individual's work by a community. Thus a user can develop a reputation and may accumulate prestige as a result of the responses of numerous users of the system.

A shortcoming of the prior art is that an effective method has not been provided whereby artists can gain recognition and prestige on a broad scale and as a result of their work without the help of traditional venues such as museums, galleries, and occasionally reputed publications. Using the system described herein artists may gain widespread recognition for their work as a result of their own initiative (i.e. by creating works and uploading information to the web-site described in the context of this invention) and without relying on third parties (i.e. parties other than the artist and the audience). This is of particular value to marginalized social groups, which may be excluded from mainstream venues but may nevertheless produce, consume, and value art in various forms.

In addition to providing collaborative filtering schemes based on user supplied ratings there have been web-based systems described in the prior art in which users are able to submit reviews. For instance the online retailer Amazon.com (http://www.Amazon.com) provides a means for users to rate and review products. Amazon's rating system aggregates user ratings into an average customer rating displayed alongside product information in response to user queries. Amazon also allows users to score reviews supplied by other users. Users wishing to score reviews declare whether or not a review was “helpful”. Amazon's rating system then aggregates user-supplied ratings of user-supplied product reviews. Users gain recognition on Amazon's website for their reviews by receiving a “helpful votes” score—an aggregate score of user responses to all reviews written by said reviewer—and a rank relative to other users writing reviews.

The invention described herein also includes a scheme whereby users may rate reviews written by other users. In the context of this invention such a rating scheme provides an important added value: review authors can gain recognition as art critics and artists can benefit from valuable critiques. Importantly, this can occur without the intercession of institutions that have traditionally mediated this relationship—i.e. art galleries, museums, and recognized art magazines and scholarly journals. The rating system provides an incentive both for artists and reviewers to use the system—both can gain recognition for their efforts. Additionally items of higher quality can be more readily identified.

As mentioned above, a salient feature of the invention disclosed herein is the provision of a means whereby a user is informed of which art is accessible in a given time and location. One important aspect of this is that it makes public art, such as street art and graffiti, more accessible to a potentially interested public. One way in which individuals could previously view street art has been through “tours” of street art which have been offered in various locations. In such tours a group of people move between successive locations viewing notable works of public art. Such tours generally involve a leader or tour guide. While such tours do provide an appealing way for individuals to gain more exposure to public art, they do not provide any means for allowing the viewing individuals to exercise their discretion in choosing which pieces to view because the tour route is typically chosen by the tour guide.

There are services known that provide a user with event or recreation information based on location and time criteria. One such popular web-based service is moviefone (http:movies.aol.com). This service allows a user to enter location information as well as date information and presents the user with information regarding available movie show-times in the desired area and on the specified date. Additionally, online services are known that describe available services more generally in a given location during specified times. For instance, the popular magazine series Time Out has a web based component (http://www.timeout.com). Also, the service Citysearch (http://www.citysearch.com) provides event, restaurant, and other recreational listings as well as providing a rating system. Citysearch users can rate listed items and also enter reviews. User ratings and reviews are used to score items and preferentially present the most popular items. Both Time Out and Citysearch though fail to give users the option to freely post event, exhibition, or installation information for other users to see and review. Thus, although these systems provide online listings of potential interest and allow users to rate these listings they do not use popular opinion to promote works that would potentially remain little seen as a consequence of the fact that individual users can not freely upload information regarding their work. Additionally, even in cases where these services provide information regarding art exhibits they do not include entries describing individual pieces. This limits their utility for providing constructive advice and generating recognition and reputation with respect to different pieces of art, as well as limiting the detail with which a user of the system can know what he/she will go to see. An additional benefit of individually listing works of art rather than whole exhibitions (and one that is novel to the invention disclosed herein) is that curators and gallery owners can gain information about which works are most popular and preferentially display those works in public viewing spaces.

An additional event listing feature has been offered by the popular social networking service Facebook (http://eww.facebook.com). The event listing feature of Facebook does allow users of the service to post their own events. Additionally, users can search event listings by event type, or by their network, which refers to a grouping of users and events in the Facebook system. Although Facebook does allow users to enter information regarding exhibit events, the service is not targeted towards entries regarding individual artifacts. Thus it does have shortcomings similar to the services described above. Additionally, no mechanism is provided for users to rate events, although users are able to post comments regarding events. Thus, Facebook does not include a method for aggregating user responses into individual scores referring to user-described artifacts. This prevents the development of effective systems of peer-generated reputation and recognition as well as preventing effective collaborative filtering.

The popular web-site MySpace (http://www.myspace.com) also provides event listings which are searchable by date, keyword, location, and time. MySpace also provides a service where performance groups and film-makers can post information regarding their work, as well as music, images, and videos. Users can upload information describing, for instance, performance times. Like Facebook and the other services described above though MySpace does not provide a system for posting individual artifacts and also does not provide a rating system or method of aggregating user responses.

An additional web-based service that has gained popularity is YouTube (http://www.YouTube.com). YouTube provides a means for users to upload videos to an online server. These videos can then be viewed by other users of the service. YouTube also includes a means for registered users to rate videos. Additionally, users can post comments and responses to posted videos, both in the form of text or as uploaded videos. YouTube does present users with aggregate ratings for videos, which are averages of ratings supplied by individual users. In relation to the invention disclosed herein YouTube has some of the same shortcomings as the systems described above. Although users are able to post responses to individual videos only posted videos can be rated by other users. Thus written reviews can not be rated by other users. YouTube does not address the issue of making art more accessible to audience members who wish to view original artworks in person. It is effective only at broadening an audience for user-uploaded digital videos viewed online.

The invention disclosed herein facilitates the formation of a broad community of artists, reviewers, and interested individuals by making accessible a broad variety of art forms and facilitating discussion and popularization of various works, artists, and writings.

Thus, in light of the standing need for a method to make a broader range of art more accessible and to facilitate the formation and expansion of a community of users interested in art, the method of this invention is disclosed.

### OBJECTS AND ADVANTAGES

Thus, the objects the invention disclosed herein are:
(a) to provide a method whereby an individual may determine what art is available for viewing in a given place and time;
(b) to provide a method whereby individuals may publicize their art works and gain a broadened audience without relying on museums or art galleries;
(c) to provide a system wherein individuals can gain popular recognition for their work as artists, as reviewers or critics of art, or as collectors and presenters of art; and
(d) to provide a method whereby art that is not part of the main stream can be made accessible to any interested individual.

Further objects and advantages will become apparent from a consideration of the following description and drawings.

### SUMMARY OF THE INVENTION

The present invention provides a method for making works of art accessible to a broad viewing public even in cases where this art is not presented in traditional venues. Additionally the invention provides a venue for criticism, review, and discussion of art by all users. The invention furthermore provides a method for users to provide ratings of art works, reviews, and collections of works. Thus the present invention provides a means whereby artists, reviewers, collectors, and an interested public can interact without the intercession of limiting bodies.

### DRAWINGS—BRIEF DESCRIPTION OF THE FIGURES

The accompanying drawings, which are incorporated into and constitute a part of this specification, illustrate one or more embodiments of the present invention and, together with the detailed description, serve to explain the principles and implementations of the invention.

In the drawings:

FIG. 1 shows a block diagram of components of a system for storing, transmitting, and retrieving information in accordance with one embodiment of the present invention.

FIG. 2 shows a block diagram of a database used in the system in accordance with one embodiment of the present invention.

FIG. 3 shows a flowchart illustrating the process of adding additional artifacts to the system according to one embodiment of the present invention.

FIG. 4 shows a flowchart of the process by which users can upload rating scores to the system regarding artifacts which they have accessed.

FIG. 5 shows a flowchart of the process by which artifact ratings are determined from a multiplicity of user-supplied artifact rating scores.

FIG. 6 shows a flowchart of the process by which a user is presented with information regarding accessible artifacts FIG. 7 shows a flowchart of the process by which users may upload reviews to the system.

FIG. 8 shows a simplified flowchart of the process by which users upload rating scores to the system regarding reviews.

FIG. 9 shows a flowchart of the process by which review ratings are determined from a multiplicity of user-supplied review rating scores.

FIG. 10 shows a flowchart of the process by which users may upload collections to the system.

FIG. 11 shows a flowchart of the process by which users supply rating scores to collections.

FIG. 12 shows a simplified flowchart of the process by which collection ratings are determined from a multiplicity of user-supplied collection rating scores.

FIG. 13 shows a flowchart of the process by which the user ratings—user artifact rating, user review rating, and user collection rating—are determined.

### DETAILED DESCRIPTION

Embodiments of the present invention are described herein in the context of a system, method, and apparatus for providing users with an on online venue for both publicizing as well as retrieving information regarding works of art as well as other works of human endeavor. These works are referred to as artifacts. The present invention further provides users with a venue for publicizing and retrieving descriptions, criticisms, and other responses to artifacts. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines.

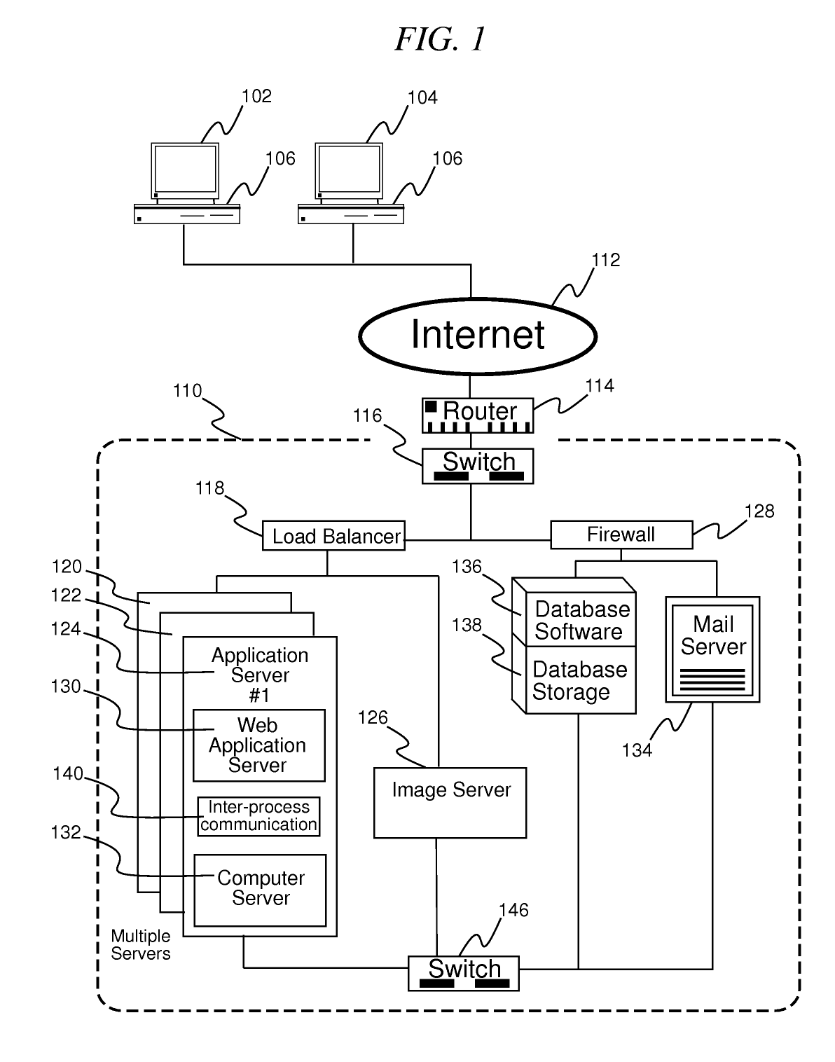

FIG. 1 illustrates the general architecture of a system that operates in accordance with one embodiment of the present invention. As shown in FIG. 1, a plurality of graphical user interface (GUI) displays 102 & 104 are presented on a plurality of user interface devices 106 & 108 connected to an apparatus 110 via the Internet 112. The user interface may be any device capable of presenting data, including, but not limited to, cellular telephones, television sets or hand-held “personal digital assistants.” As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services. As described herein, the exemplary public network of FIG. 1 is for descriptive purposes only. Although the description may refer to terms commonly used in describing particular public networks such as the Internet, the description and concepts equally apply to other public and private computer networks, including systems having architectures dissimilar to that shown in FIG. 1. For example, and without limitation thereto, the system of the present invention can find application in public as well as private networks, such as a closed university social system, or the private network of a company.

The apparatus 110 is connected to the Internet 112 through a router 114 and a switch 116. As is well known in the relevant art(s), routers forward packets between networks. The router 114 forwards information packets between the apparatus 110 and devices 106 & 108 over the Internet 112. A load balancer 118 balances the traffic load across multiple mirrored servers 120, 122, 124 and a firewall 128 provides protection from unauthorized access to the apparatus 110. The switch 116 may act as a gatekeeper to and from the Internet 112. The components appearing in the apparatus 110 refer to an exemplary combination of those components that would need to be assembled to create the infrastructure in order to provide the tools and services contemplated by the present invention. As will be apparent to one skilled in the relevant art(s), all of components “inside” of the apparatus 110 may be connected and may communicate via a wide or local area network (WAN or LAN).

The apparatus 110 includes an application server 124 or a plurality of application servers 124. The application server 124 comprises a web application server 130 and a computer server 132 that serves as the application layer of the present invention. Yet another server is the image server 126, which has the purpose of storing and providing digital images to other components of the apparatus 110. Also included is a mail server 134, which sends and receives electronic messages to and from devices 106 & 108. Also included are the database software 136 and a database 138.

The Web application server 130 is a system that sends out Web pages in response to Hypertext Transfer Protocol (HTTP) requests from remote browsers (i.e. users of the apparatus 110). That is, the Web server 130 provides the GUI 102 & 104 to users of the system in the form of Web pages. These Web pages sent to the user's device 106 & 108 would result in GUI screens 102 & 104 being displayed.

The apparatus 110 also includes a second switch 140 that allows the components of the apparatus to be interconnected in a local area network (LAN) or a wide area network (WAN). Thus, data can be transferred to and from the various components of the apparatus 110.

As will be appreciated by those skilled in the relevant art(s), this configuration of router 114 and switch 116 is flexible and can be omitted in certain embodiments. Additional routers 114 and/or switches 116 can also be added.

The application server 124, the database(s) 136, 138 and the mail server 134 are shielded from the public Internet 112 through the firewall 128. The firewall 128 is a dedicated gateway machine with special security precaution software. It is typically used, for example, to service Internet 112 connections and dial-in lines and protects the cluster of more loosely administered network elements hidden behind it from external invasion. Firewalls are well known in the relevant art(s).

As will be appreciated by those skilled in the relevant art(s), the inclusion of the firewall 128 is flexible and can be omitted in certain embodiments. Additional firewalls 128 can also be added.

The computer server 132 may include a central processing unit (CPU), a random access memory (RAM) temporary storage of information, and a read only memory (ROM) for permanent storage of information. Computer server 132 may be generally controlled and coordinated by an operating system software. The operating system controls allocation of system resources and performs tasks such as processing, scheduling, memory management, networking and I/O services, among things. Thus, the operating system resident in system memory and executed by CPU coordinates the operation of the other elements of the apparatus 110.

Although the description of the computer server 132 may refer to terms commonly used in describing particular computer servers, the description and concepts equally apply to other processing systems, including systems having architectures dissimilar to that shown in FIG. 1.

Also included is an inter-process communications protocol 140 (IPCP), a set of rules for marshalling and un-marshalling parameters and results. This is the activity that takes place at the point where the control path in the calling and called process enters or leaves the IPCP domain. The IPCP is essentially a set of rules for encoding and decoding information transmitted between multiple processes.

As will be appreciated by those skilled in the relevant art(s), the inclusion of the IPCP 140 is flexible and can be substituted or omitted in certain embodiments.

The apparatus 110 may also include the image server 126 or a plurality of image servers that manage(s) digital photographs and other human viewable images. The image server 126 may be configured separately from the web server 130. This configuration may increase the scalability of the server apparatus 110. Alternatively, the web server 130 and the image server 126 can be configured together. Examples of image formats that can be managed by the image server 126 include, but are not limited to, Graphical Interchange Format (“GIF”), Joint Photographics Experts Group (“JPEG”), or Portable Network Graphics (“PNG”) or Tagged Image File (“TIF”).

The mail server 134 is a repository for e-mail messages received from the Internet 112. It also manages the transmission of electronic messages (“electronic mail” or “e-mail”). The mail server 134 consists of a storage area, a set of user definable rules, a list of users and a series of communication modules. Its primary purpose in the present invention is the storage and distribution of e-mail messages to the Internet 112.

The databases 136, 138 store software, descriptive data, digital images, system data and any other data item required by the other components of the apparatus. The databases may be provided, for example, as a database management system (DBMS), and object-oriented database management system (ODBMS), a relational database management system (e.g. DB2, ACCESS etc.), a file system or another conventional database package. Thus, the databases 136 & 138 can be implemented using object-oriented technology or via text files. Further, the databases 136 & 138 can be accessed via a Structured Query Language (SQL) or other tools known to one of ordinary skill in the art.

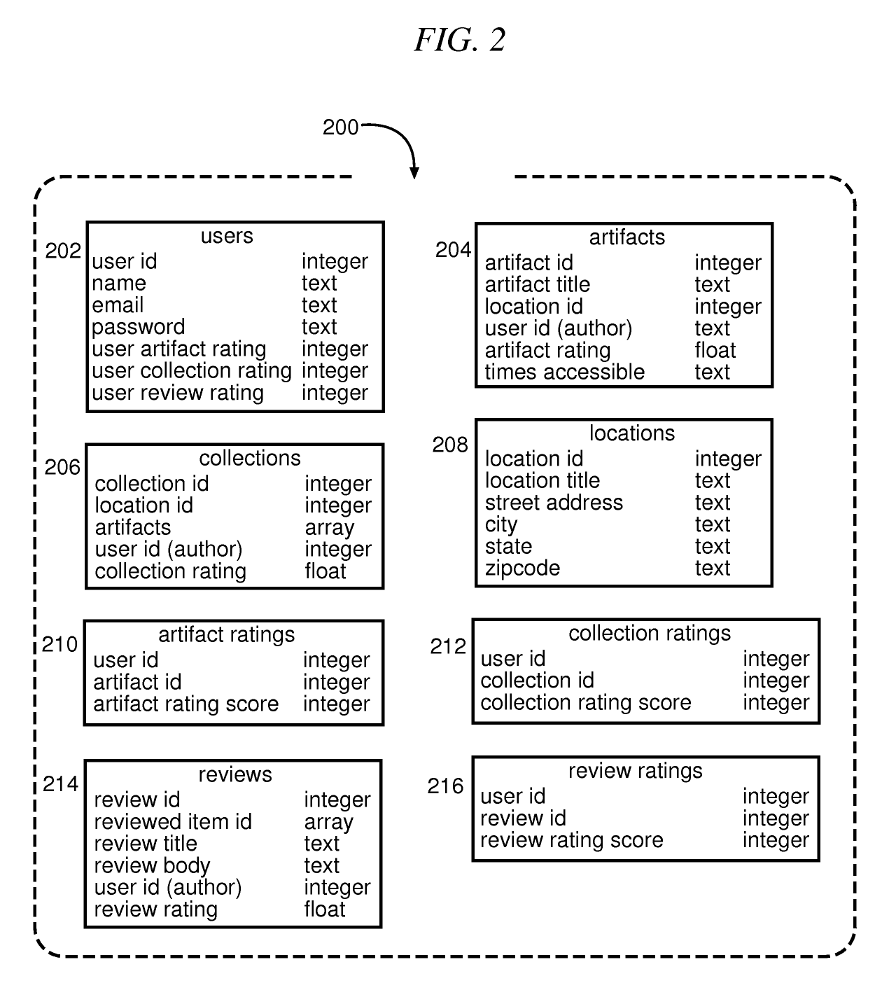

FIG. 2 shows a block diagram of an example of one implementation of a database 200 in accordance with one embodiment of the present invention. The database 200 may be provided, for example, as a database management system (DBMS), an object-oriented database management system (ODBMS), a relational database management system (e.g. DB2, ACCESS etc.) or another conventional database package. Thus, the database 200 can be implemented using object-oriented technology or via text files. Further, the database 200 can be accessed via a Structured Query Language (SQL) or other tools known to one of ordinary skill in the art.

The implementation of the database 200 shown in FIG. 2 comprises several categories of information. These categories include user data, artifact data, and collection data.

In the description of the present embodiment user data refers to information that describes a user. User data may include such entries as appear in table 202 of the exemplary database 200 of FIG. 2. Entries in a table containing user data include a user name, an email address for a given user, and a password to be used by the user in order to access the system. In an exemplary embodiment of the invention these data items can be defined by the user though the user may be constrained by certain limitations imposed by the system. These limitations may include for instance limitations on the number of characters allowed for a data item, or preventing multiple users from choosing the same user name.

Additionally there are data items in the user data category that are determined without the direct control of the user they describe. These may include a user id number automatically assigned by the system to each user. Also, one or more ratings may be automatically assigned by the system to a user. The preferred embodiment of the invention includes three such ratings: a user artifact rating, a user collection rating, and a user review rating. These ratings are determined by aggregating ratings supplied by individual users with reference to specific artifacts, collections, or reviews. The user artifact rating, for instance, refers to a combination of all of the artifact ratings for artifacts associated with, and potentially created by, a given user. In the present embodiment of the invention this combination is achieved by determining the arithmetic mean of the individual artifact ratings.

### Artifacts

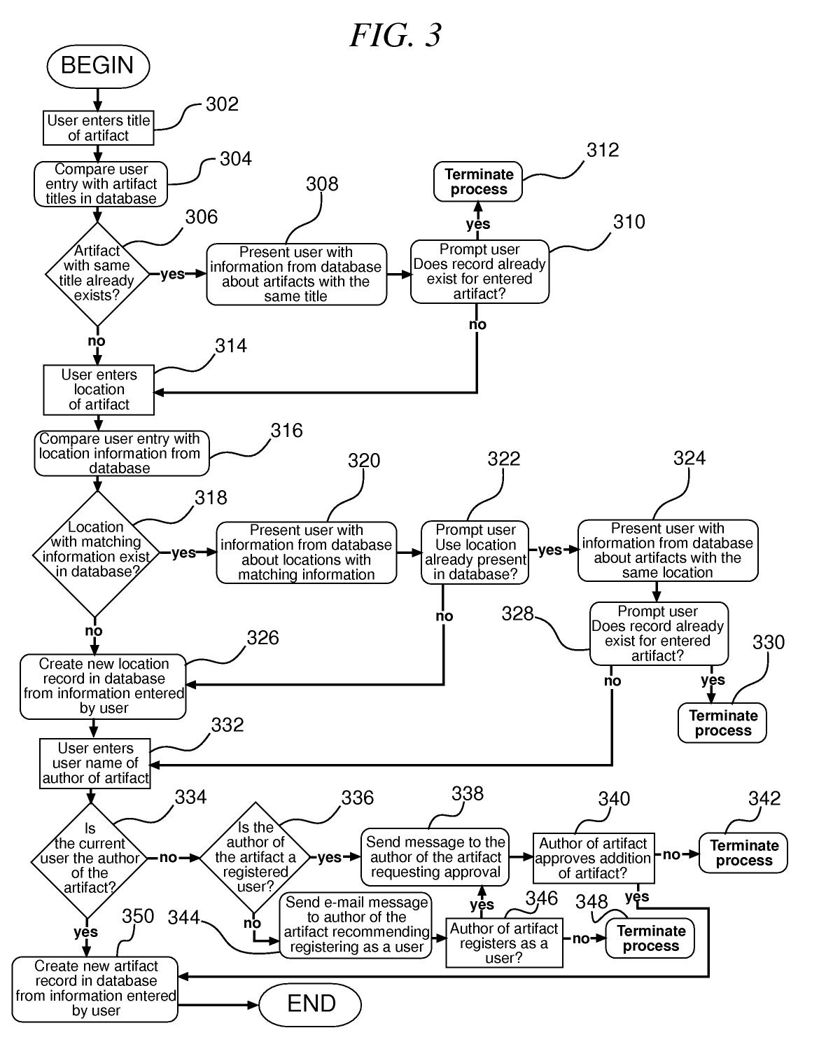

Reference is now made to FIG. 3 which shows a simplified flowchart of the process for adding additional artifacts to a database according to one embodiment of the present invention. The capability of users to add artifacts to the database is central to the operation of the invention disclosed herein. At 302 an artifact title is entered. The artifact title may be, for instance, in the case of a painting, the title of said painting. At 304 the artifact title entered at 302 is compared with artifact titles in a database, illustrated as 138 in FIG. 1. The purpose of the process illustrated in FIG. 3 is to add artifacts to the database which were not previously present in the database. At 306 the system determines whether one or more entries already exist in the database 138 with titles matching that entered at 302. If artifacts are present in the database 138 with the same or similar titles to that entered at 302 then at 308 the user is presented with information regarding said artifacts with the same or similar titles. Information regarding these artifacts is retrieved from the database 138. The user is then prompted at 310 to declare whether or not an entry already exists in the database 138 describing the artifact whose title was entered at 302. If an entry already exists in database 138 for said artifact then the process is terminated at 312 because there is no need to create a duplicate database entry.

If the user declares at 310 that the artifact whose title was entered at 302 is not among those presented at 308 then the process proceeds to 314. Alternatively, if the system determines at 306 that an artifact with the same title as that entered at 302 does not exist the process proceeds to 314.

At 314 the user enters the location of the artifact whose title was entered at 302. At 316 the location information entered at 314 is compared with location information present in the database 138. At 318 the system determines whether one or more entries exist in the database 138 with information matching that entered at 314. If no entry is found in the database 138 that contains information matching that entered at 314 then the process proceeds to 326. If an entry is found in the database 138 which describes a matching location then the process proceeds to 320. At 320, the user is presented with information regarding locations that have matching information to the information entered by the user at 314. At 322 the user is prompted to declare whether a previous database entry describing a location adequately describes the location information entered at 314. If the user declares at 322 that an entry does not already exist in the database 138 which adequately describes the location entered at 314 then the process proceeds to 326. At 326 a new database entry describing a location is created in the database 138 based on the information provided by the user at 314. Table 208 of FIG. 2 shows an exemplary structure of a database entry describing a location. The process then proceeds to 332.

If the user declares at 322 that an entry already exists in the database 138 which adequately describes the location entered at 314, then at 324 the user is presented with information from the database 138 that describes artifacts associated with said entry. At 328 the user is prompted to declare whether a record already exists for the artifact entered at 302. This step is included so that the user may decline to create multiple database entries for the same artifact with different titles. If the user declares at 328 that an entry does already exist in the database 138 for the artifact entered at 302 then the process terminates at 330.

At 332 the user enters a user name of the author of the artifact entered at 302. In the preferred embodiment of the invention disclosed herein the author of an artifact is synonymous with the creator of said artifact. At 334 the system determines whether the current user—i.e. the user who has been interacting with the system in the process described by the flowchart of FIG. 3—is the author of the artifact entered at 302. If the system determines at 334 that the current user is the author of the artifact entered at 302 then the process proceeds to 350.

If the system determines at 334 that the current user is not the author of the artifact entered at 302 then the process proceeds to 336. At 336 the system determines whether the author of the artifact is a registered user of the system. In the preferred embodiment of the invention this can be accomplished by comparing the user name of the author of the artifact entered at 332 with user names of known users of the system. A format for storing information regarding users of the system is pictured in table 202 of FIG. 2. This comparison may be accomplished by various methods known in the art including use of structured query language (SQL) implemented in the database software 136 to perform a search of the database 138. The pairing of database software 136 with database storage 138 is pictured in FIG. 1.

If the system of the present invention determines at 336 that the author of the artifact entered at 302 is a registered user of said system then the process proceeds to 338. At 338 the system sends a message to the author of the artifact requesting approval for the addition of an entry to the database 138 describing the artifact entered at 302. Said message sent at 338 may be generated and sent using various methods known in the prior art including the use of a mail server pictured as 134 in FIG. 1. At 340 the system determines whether the author of the artifact entered at 302 has responded to the message sent at 338 by approving the addition of an entry to the database 138 describing the artifact entered at 302. If the system determines at 340 that the author of the artifact entered at 302 does not approve the addition of an entry to the database 138 describing said artifact then the process is terminated at 342. Thus in the present embodiment of the invention disclosed herein artifacts may only be included in the database 138 with the approval of their authors. Alternatively, if the system determines at 340 that the author of the artifact entered at 302 does approve the addition of an entry to the database 138 describing said artifact then the process proceeds to 350.

If the system of the present invention determines at 336 that the author of the artifact entered at 302 is not a registered user of said system then the process proceeds to 344. At 344 the user is prompted to enter contact information for the author of the artifact entered at 302, and based on said contact information the system sends an email message to the author of said artifact. In the present embodiment of the invention described herein said email message recommends registration with the system described herein. If the system determines at 346 that the author of the artifact entered at 302 has registered as a user the process described herein proceeds to 338. If a given period time has elapsed from the time at which the message at 344 was sent and the system determines at 346 that the author of the artifact entered at 302 has failed to register as a user of the system then the process terminates at 348.

At 350 a new entry is created in the database 138 describing an artifact and based on information collected at various stages between 302 and 350 in the process illustrated in FIG. 3. In the preferred embodiment of the invention described herein said entry has the structure illustrated by table 204 of FIG. 2.

The new entry created in the database 138 at 350 contains several pieces of data as illustrated by table 204 of FIG. 2. These various pieces of data are determined as follows in the preferred embodiment of the invention disclosed herein. “Artifact id” is a number assigned to an entry in database 138 as created at 350 for the purpose of reference within the system. “Artifact title” is the artifact title entered by the user at 302. “Location id” is a number assigned by the system and used to refer to an entry in the database 138 describing a location. Said entry describing a location is defined by the user at 314, or identified by the user at 322 from previous entries. “User id (author)” is a number assigned by the system which refers to an entry in database 138 that contains user information describing the author of the artifact entered at 302. “Artifact rating” is a number assigned by the system to an artifact based on user supplied rating scores. “Times accessible” describes the times during which the artifact described by the database entry created at 350 can be accessed. In the preferred embodiment of the invention the same user who enters the artifact title at 302 enters into the system a description of the times during which said artifact may be accessed.

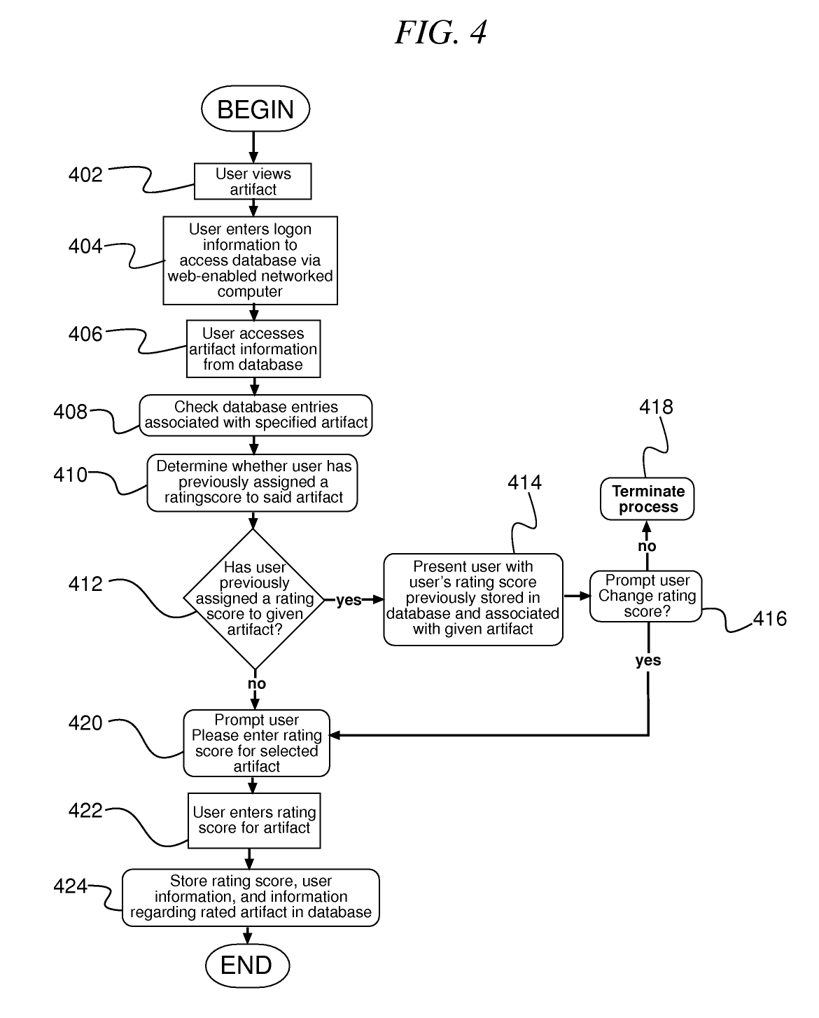

Table 204 of FIG. 2 includes among the data items in an exemplary entry describing an artifact in the system disclosed herein an item called “artifact rating”. Above it is mentioned that the content of the data item “artifact rating” is a number assigned by the system to an artifact based on user supplied rating scores. FIG. 4 shows a simplified flowchart for the process by which users supply said rating scores. In the preferred embodiment of the invention disclosed herein said user supplied rating scores are numerical scores within a certain range (between 1 and 10, for example).

It is one of the objectives of the invention disclosed herein to provide a venue for the democratic evaluation, discussion, and publication of works of art and other artifacts. One of the ways in which this is accomplished is by providing a means whereby each user who has viewed or otherwise accessed an artifact may provide his/her reaction to said artifact. A cumulative score is generated by combining the reactions of all of the users who have entered their reactions into the system. This cumulative score reflects the response an artifact has generated from the community of users. This cumulative score can then be used by users as a criteria for determining which artifacts to view.

Reference is now made to FIG. 4 which shows a simplified flowchart of the process by which users supply rating scores to artifacts which they have accessed. The rating process begins when a user accesses an artifact so that he/she may develop an opinion of said artifact. At 402 an artifact is accessed by a typical user of the system described herein. In the case where the accessed artifact is a painting, for instance, accessing the artifact may entail viewing said artifact. It should be noted here that the system described herein is also intended to facilitate viewing of artifacts by providing information regarding the accessibility of artifacts. The times during which an artifact is accessible, for instance, is stored under the heading “times accessible” in the exemplary database entry structure 204 which is used to describe an artifact. Additionally users may be provided with reviews relevant to certain artifacts and supplied by other users of the system. Reviews are further discussed below under the heading “Reviews”.

After a user has accessed an artifact at 402, said user logs on to the system described herein. At 404 said user enters his/her logon information into system via a web-enabled networked computer. In order to associate a rating score with the specific artifact viewed at 402 the user must identify the entry describing said artifact within the system. This step is illustrated at 406. This may be accomplished by searching through the database using criteria including: artifact name, author name, or artifact location.

In order to promote the fairness of the evaluation scheme described herein, each user may contribute only one rating to the overall rating score of each artifact. Thus it is necessary to associate a user name with each rating score. The method for storing artifact rating scores is illustrated in table 210 of FIG. 2, which shows an exemplary structure for a database entry describing an individual artifact rating. At 408 the system retrieves entries from the database associated with the artifact identified by the user at 406. At 410 the system then determines whether the user has previously assigned a rating score to said artifact. If the user has not previously entered a rating score for the specified artifact then the process proceeds to 420. If the user has previously entered a rating score for the specified artifact then the process proceeds to 414. At 414 the user is presented with the rating score previously stored in the database 138 and associated with said user (who has entered logon information at 404) and said selected artifact (identified at 406). Then, at 416 the user is prompted to declare whether he/she would like to change the rating score from that presented at 414. If the user declines to change said rating score then the process terminates at 418. If the user elects to change said rating score then the process proceeds to 420.

At 420 the user is prompted by the system to enter a rating score for the artifact identified at 406. At 422 the user enters a new rating score for said artifact. In the preferred embodiment of the invention said rating score may be a number between 1 and 10. At 424 said new rating score is stored in the database along with information describing the artifact and information describing the user. Table 210 shows a preferred format for storing this information as an “artifact rating” entry in database 138.

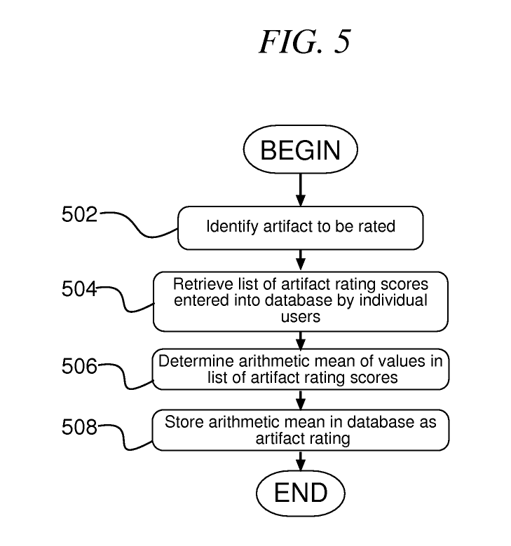

One principle purpose of allowing each user to rate artifacts in the manner described above and as illustrated in FIG. 4 is to provide a means for popular rating of artifacts. As in most voting systems, a method is necessary for aggregating votes. In the system disclosed herein a method is included whereby the multiplicity of individual votes entered by various users of the system can be aggregated into a single score describing a given artifact. The single rating score assigned to an artifact based on an aggregation of user ratings is called an artifact rating and is illustrated in table 204 of FIG. 2. The process by which an artifact rating is determined from individual artifact rating scores is illustrated in FIG. 5.

Reference is now made to FIG. 5 which shows a simplified flowchart of the process by which artifact ratings (illustrated in table 204 of FIG. 2) are calculated from artifact rating scores (illustrated in table 210 of FIG. 2). At 502 the system of the invention disclosed herein identifies an artifact for which the artifact rating should be updated. In the preferred embodiment of the invention this is achieved by updating the artifact rating of a given artifact automatically after a user has changed or added an artifact rating score for said artifact. In such a configuration the process illustrated in FIG. 5 is triggered by the completion of the process illustrated in FIG. 4 if said latter process involves the addition or change of an artifact rating score (i.e. termination of the process illustrated in FIG. 4 after step 424). Alternate schemes for determining a artifact rating update schedule are possible though. Such alternate schemes may include periodic updating of all artifact ratings or updating of a given artifact rating only after a specified number of individual artifact rating scores have been changed. These alternate schemes do not change the spirit of the invention and are considered ramifications.

After an artifact has been identified at 502 as a candidate for the updating process illustrated in FIG. 5, the process proceeds to 504. At 504 a list of artifact rating scores associated with said artifact identified at 502 is created based on artifact rating entries (illustrated as table 210 of FIG. 2) stored in database 138. The list of artifact rating scores created at 504 is comprised of all of the artifact rating scores associated with a given artifact. Each item in said list furthermore represents the opinion of a single user and each item represents the opinion of a different user. This is ensured by the process illustrated in FIG. 4, which allows for each user of the system described herein to supply only a single artifact rating score for each artifact.

Next, at 506 the arithmetic mean of the user supplied artifact rating scores aggregated in the list created at 504 is calculated. In the preferred embodiment of the invention artifact ratings are calculated by determining the arithmetic mean of all user supplied artifact rating scores for said artifact. Alternate schemes are possible and constitute ramifications of the invention disclosed herein. For example, artifact ratings may be calculated by determining a weighted average of user supplied artifact rating scores in which the artifact ratings scores supplied by some users are more or less highly weighted than others.

Finally, at 508 the arithmetic mean of the user supplied artifact rating scores aggregated in the list created at 504 is stored in the database 138. Said arithmetic mean is stored under the heading of “artifact rating” as illustrated in table 204 of FIG. 2.

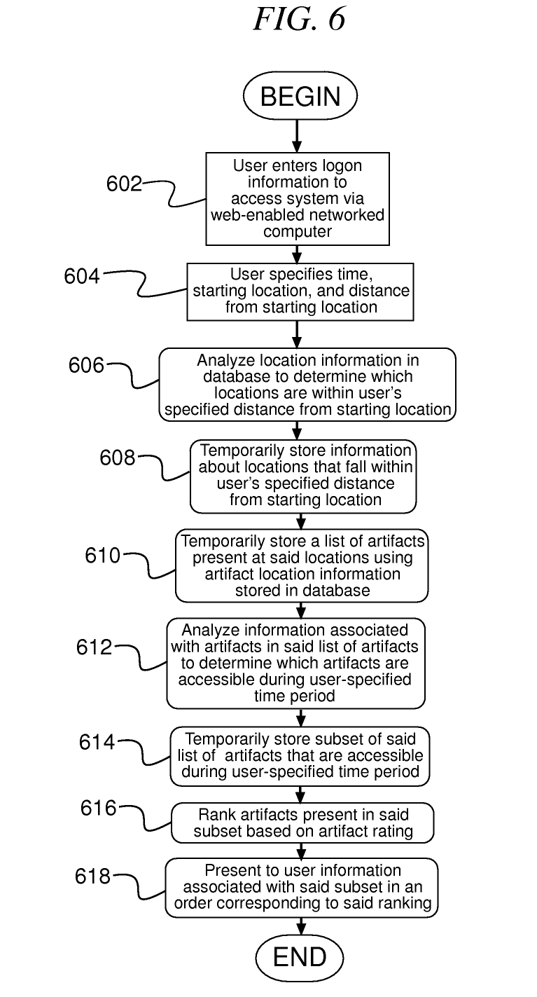

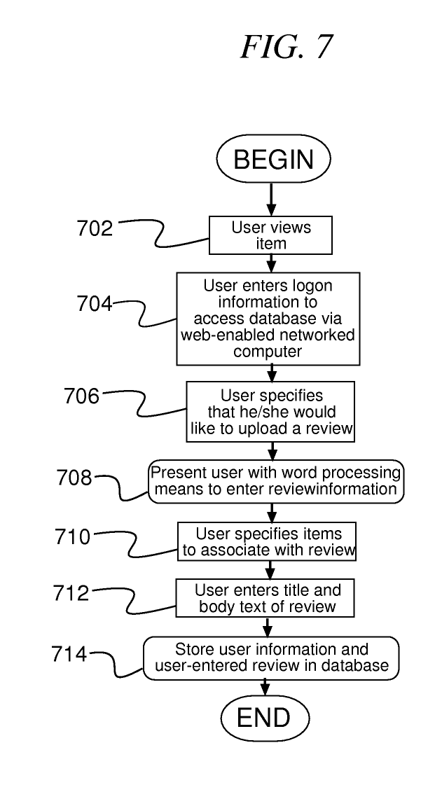

One objective of the invention disclosed herein is to provide a means through which a user may determine what artifacts are accessible during a certain time period and in a certain geographical location. For instance, an individual in the city of Chicago wishing to view paintings after 10:00 pm on a Friday night can log onto the system described herein and receive information regarding accessible paintings. Thus by using the system described herein an individual may fulfill his/her desire to view paintings despite the fact that the majority of public art museums and galleries will be closed at 10 pm in Chicago. The rating scheme described above is an important element of this system as it provides the user with a criterion for judging which artifacts to view—in the absence of a curator or gallery owner a user must have some basis for choosing which artifacts to access. FIG. 6 illustrates the process by which a user wishing to access artifacts with the help of the system disclosed herein may do so.

Reference is now made to FIG. 6 which shows a simplified flowchart of the process by which a user is presented with information regarding accessible artifacts. At 602 a user enters logon information in order to access the system via a web-enabled networked computer. At 604 said user initiates a search for accessible artifacts by entering a time, a starting location, and a search radius relative to the starting location. At 606 the system described herein analyzes the location information of artifact records in the database in order to determine which locations fall within the user-specified search radius from the user-specified starting location. Table 208 of FIG. 2 shows an exemplary data structure for storing location information. At 608 references to locations which fall within the user-specified search radius relative to the starting location are temporarily stored in a list. Table 208 of FIG. 2 shows a “location id” data item within the data structure for storing location information. This data item is used for internal reference within the system described herein. Thus, in the preferred embodiment of the invention disclosed herein, the list of references to locations stored at 608 is a list of “location id” numbers.

The purpose of the user search initiated at 604 is to identify accessible artifacts. Thus, once a list of suitable locations has been created at 608, this list must be converted into a list of corresponding artifacts. Table 204 of FIG. 2 shows an exemplary data structure for storing information regarding artifacts. This table shows within the data structure for storing information regarding artifacts a data item called “location id”. This corresponds to the “location id” used by the system to refer to location data entries (described above and illustrated in table 208 of FIG. 2). Thus, each artifact record is associated with a location record which describes the location of the artifact described by said artifact record. At 610 the system identifies and creates a list of references to all artifact entries in the database 138 for which the stored “location id” matches a “location id” from the list of “location id” numbers created at 608. This list of references to artifact entries is a list of “artifact id” numbers. Table 204 illustrates the inclusion of a numerical data item called “artifact id” in the exemplary data structure for entries describing artifacts in the database 138.

Thus, a list has been stored at 610 composed of references to artifacts which fall within a suitable distance from the user-specified starting location. Next, at 612 the system determines which artifacts are accessible during the time period specified by the user at 604. Information regarding the accessibility of artifacts is stored under the heading “times accessible” as illustrated in table 204 of FIG. 2. At 614 the system stores a list which is a subset of the list of artifacts generated 610, said subset composed of those artifacts which are accessible during the user specified time period. At 616 artifacts in the list stored at 614 are ordered based on their artifact ratings (see FIG. 4 and FIG. 5 for illustration of process by which artifact ratings are determined). At 618 the user is presented with information from the database 138 relating to each of the “artifact id” numbers in the ordered list generated at 616.

The information presented to the user at 618 is ordered such that more highly rated artifacts are preferentially presented. The information describing each artifact presented to the user at 618 may vary depending on the preferences of a given user. For instance a user may be presented with a list of “artifact titles” (see table 204 of FIG. 2). Additionally a user may be presented with a list of “names” of authors of the listed artifacts (see table 202 of FIG. 2). The “name” of the author of a given artifact may be retrieved from the database 138 as follows. The “user id (author)” data item in a given artifact entry (see table 204 of FIG. 2) is retrieved. This data item is a numerical reference to a user entry (see table 202) describing the author of said given artifact. In the user entry for a given author is a data item called “name” which contains the name of said given author.

Thus, the process illustrated by the simplified flowchart of FIG. 6 shows a method whereby a user may be presented with a list of artifacts that are accessible during a specific time and in a specific geographical location. Furthermore the process of FIG. 6 includes a means for preferentially presenting said user with information regarding artifacts that have been highly rated by other users of the system described herein.

### Reviews

A general purpose of the invention disclosed herein is to provide a system for the popularization of various art forms. It is recognized that works of art are often complex creations that merit extensive discussion, analysis, and critical examination. It is with in mind that the invention disclosed herein includes a method for the publication of user supplied commentary regarding the artifacts, collections, or even reviews described in the system. The process whereby a user may upload commentary in the form of a review is illustrated in FIG. 7.

Reference is now made to FIG. 7 which shows a simplified flowchart of the process by which users may upload reviews to the database 138. First, at 702 a user views an item listed in the database 138. This item may be an artifact, a collection of artifacts, a review posted by another user, or any other matter relevant to the system disclosed herein. At 704 said user enters his/her logon information via a web-enabled computer in order to access the system. At 706 the user specifies that he/she would like to upload a review. Next, at 708 the user is presented with a word processing means to enter review information. In the preferred embodiment said word processing means is a web-browser based word processing means. At 710 the user specifies which items to associate with the review he/she will enter into the system. For instance if a hypothetical user would like to write a review regarding an artifact he/she would specify the artifact which is the subject of the review. In the case a review discusses multiple artifacts multiple artifacts can be specified as associated with said review. Additionally, a user could specify any number of artifacts, collections, and reviews to associate with a given review. Next, at 712 the user enters a title for his/her review as well as the body text of said review. Finally at 714 the title, body text, user information of the author, and associated artifacts for the review entered at 712 are stored in the database 138.

Table 214 of FIG. 2 shows the preferred format for storing reviews in the database 138. As in the case of artifacts (described above) and collections (described below), each review is associated with a review id number, shown as “review id” in table 214 of FIG. 2, which is automatically assigned by the system. Each review record also contains a list of associated artifacts, collections, and reviews. This list is shown as “reviewed item id” in table 214 of FIG. 2. The information stored in this list is a list of id numbers associated with the items specified by a user as associated with a given review (see step 710 of FIG. 7). Next, table 214 of FIG. 2 specifies the storage of “review title” and “review body” which are the review title and body text of the review respectively, entered by the user at step 712 of the process illustrated in FIG. 7. Finally, table 214 specifies the storage of “user id (author)” with each review entered in the database. This refers to the user id of the author of a given review (i.e. the user who enters his/her logon information at step 704 of the process illustrated in FIG. 7). Table 214 of FIG. 2 also specifies the storage of a “review rating”. This is further discussed below.

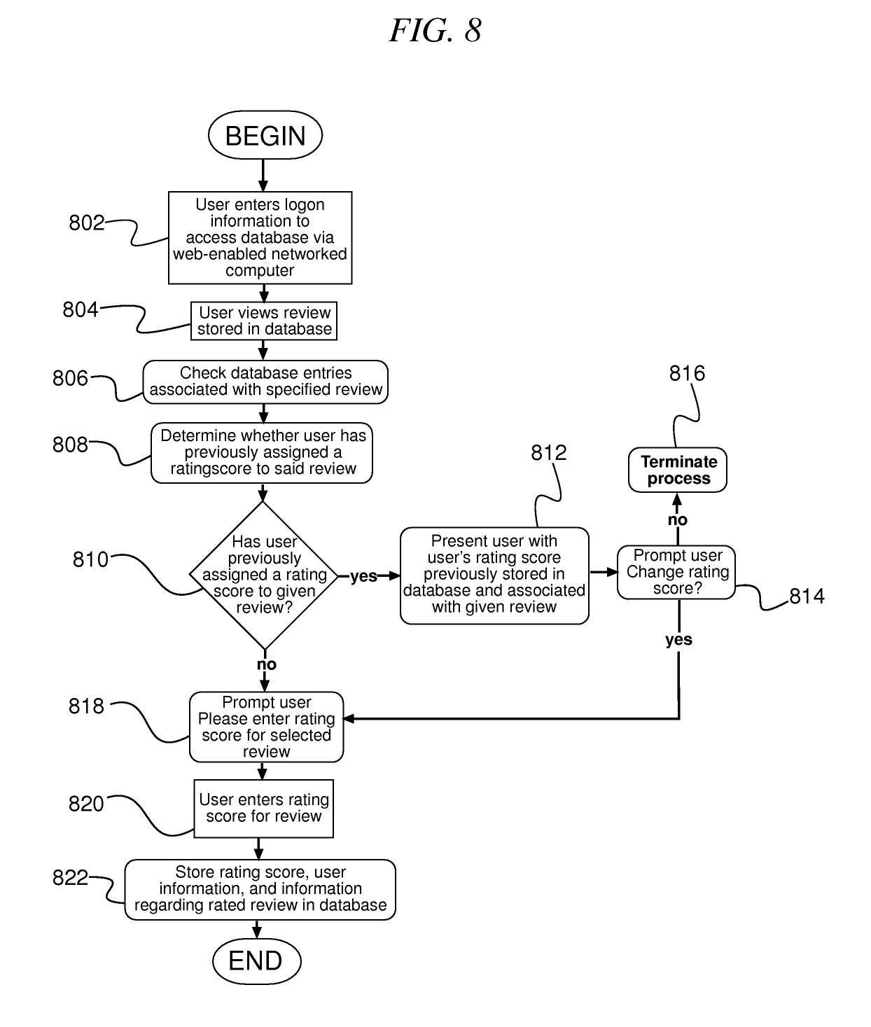

In a manner similar to the process of rating artifacts illustrated in FIG. 4, users may rate reviews. The process by which a user may rate a review is illustrated in FIG. 8. Reference is now made to FIG. 8 which shows a simplified flowchart of the process by which users supply rating scores to reviews which they have viewed. The rating process begins when a user accesses the system described herein by entering his/her logon information via a web-enabled computer. At 802 a user enters his/her logon information to access the system.

Next, the user who has entered his/her logon information at 802 views a review stored in the database 138. In the preferred embodiment of the invention disclosed herein, a user may view reviews in several ways. For instance, when a user is presented by the system with information regarding certain collections, reviews, or artifacts (e.g.) he/she may also be presented with information regarding reviews related to said collections, reviews, or artifacts. In the preferred embodiment of the invention disclosed herein, relation of a review to a given set of artifacts, collection, or other reviews is determined by the items listed in the “reviewed item id” field illustrated in table 214 of FIG. 2. Additionally a user wishing to access reviews directly may search for reviews using criteria including review title, associated items, keywords appearing in the body text of the reviews.

In order to promote the fairness of the evaluation scheme described herein, each user may contribute only one rating to the overall rating score of each review. Thus it is necessary to associate a user name with each rating score. The method for storing review rating scores is illustrated in table 216 of FIG. 2, which shows an exemplary structure for a database entry describing an individual review rating. At 806 the system retrieves entries from the database associated with the review identified by the user at 804. At 808 the system then determines whether the user has previously assigned a rating score to said review. If the user has not previously entered a rating score for the specified review then the process proceeds to 818. If the user has previously entered a rating score for the specified artifact then the process proceeds to 812. At 812 the user is presented with the rating score previously stored in the database 138 and associated with said user (who has entered logon information at 802) and said selected review (identified at 804). Then, at 814 the user is prompted to declare whether he/she would like to change the rating score from that presented at 812. If the user declines to change said rating score then the process terminates at 816. If the user elects to change said rating score then the process proceeds to 818.

At 818 the user is prompted by the system to enter a rating score for the review identified at 804. At 820 the user enters a new rating score for said review. In the preferred embodiment of the invention said rating score may be a number between 1 and 10. At 822 said new rating score is stored in the database along with information describing the review and information describing the user. Table 216 shows a preferred format for storing this information as a “review rating” entry in database 138.

It is anticipated that a large number of users will use the system disclosed herein. Thus it is further anticipated that a large number of user commentaries may be uploaded to the system. This creates the need for organizing user commentaries based on a criteria or indicator of quality. In order to organize user commentaries a means is provided whereby user commentaries are rated by users of the system. This is similar to the scheme provided for the rating of artifacts (illustrated in FIG. 4 and FIG. 5).

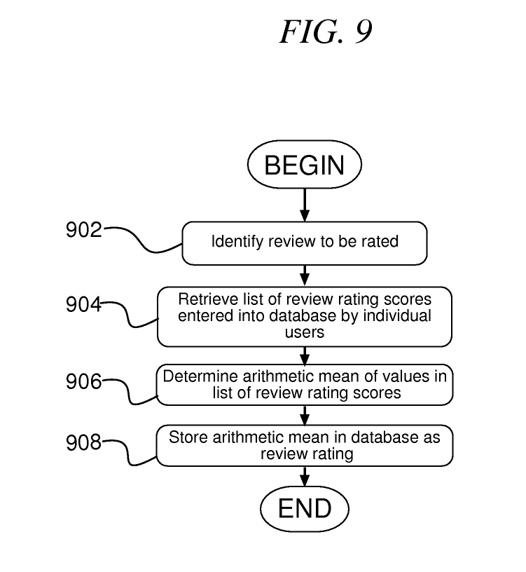

Reference is now made to FIG. 9 which shows a simplified flowchart of the process by which review ratings (illustrated in table 214 of FIG. 2) are calculated from review rating scores (illustrated in table 216 of FIG. 2). At 902 the system of the invention disclosed herein identifies a review for which the review rating should be updated. In the preferred embodiment of the invention this is achieved by updating the review rating of a given review automatically after a user has changed or added a review rating score for said review. In such a configuration the process illustrated in FIG. 9 is triggered by the completion of the process illustrated in FIG. 8 if said latter process involves the addition or change of a review rating score (i.e. termination of the process illustrated in FIG. 8 after step 822). Alternate schemes for determining a review rating update schedule are possible though. Such alternate schemes may include periodic updating of all review ratings or updating of a given review rating only after a specified number of individual review rating scores have been changed. These alternate schemes do not change the spirit of the invention and are considered ramifications.

After a review has been identified at 902 as a candidate for the updating process illustrated in FIG. 9, the process proceeds to 904. At 904 a list of review rating scores associated with said review identified at 902 is created based on review rating entries (illustrated as table 216 of FIG. 2) stored in database 138. The list of review rating scores created at 904 is comprised of all of the review rating scores associated with a given review. Each item in said list furthermore represents the opinion of a single user and each item represents the opinion of a different user. This is ensured by the process illustrated in FIG. 8, which allows for each user of the system described herein to supply only a single review rating score for each review.

Next, at 906 the arithmetic mean of the user supplied review rating scores aggregated in the list created at 904 is calculated. In the preferred embodiment of the invention review ratings are calculated by determining the arithmetic mean of all user supplied review rating scores for said review. Alternate schemes are possible and constitute ramifications of the invention disclosed herein. For example, review ratings may be calculated by determining a weighted average of user supplied review rating scores in which the review ratings scores supplied by some users are more or less highly weighted than others.

Finally, at 908 the arithmetic mean of the user supplied review rating scores aggregated in the list created at 904 is stored in the database 138. Said arithmetic mean is stored under the heading of “review rating” as illustrated in table 214 of FIG. 2.

### Collections

Involvement with art and all means of human creation extends beyond the work of authoring and critiquing. With this in mind, the system of the invention disclosed herein includes an additional type of database entry—i.e. an entry describing a collection. The activity of bringing together various artifacts into a collection may produce an added value for the user of said artifacts. For example the juxtaposition of various artifacts can draw attention to their differences and the specificities of the traditions from which they come. As another example bringing into close proximity several emotionally affecting pieces of art can produce in the viewer an emotional response more complex than the simple sum of the artifacts encountered. The system described herein includes collections both as groupings presented to users and also as subjects of review and discussion.

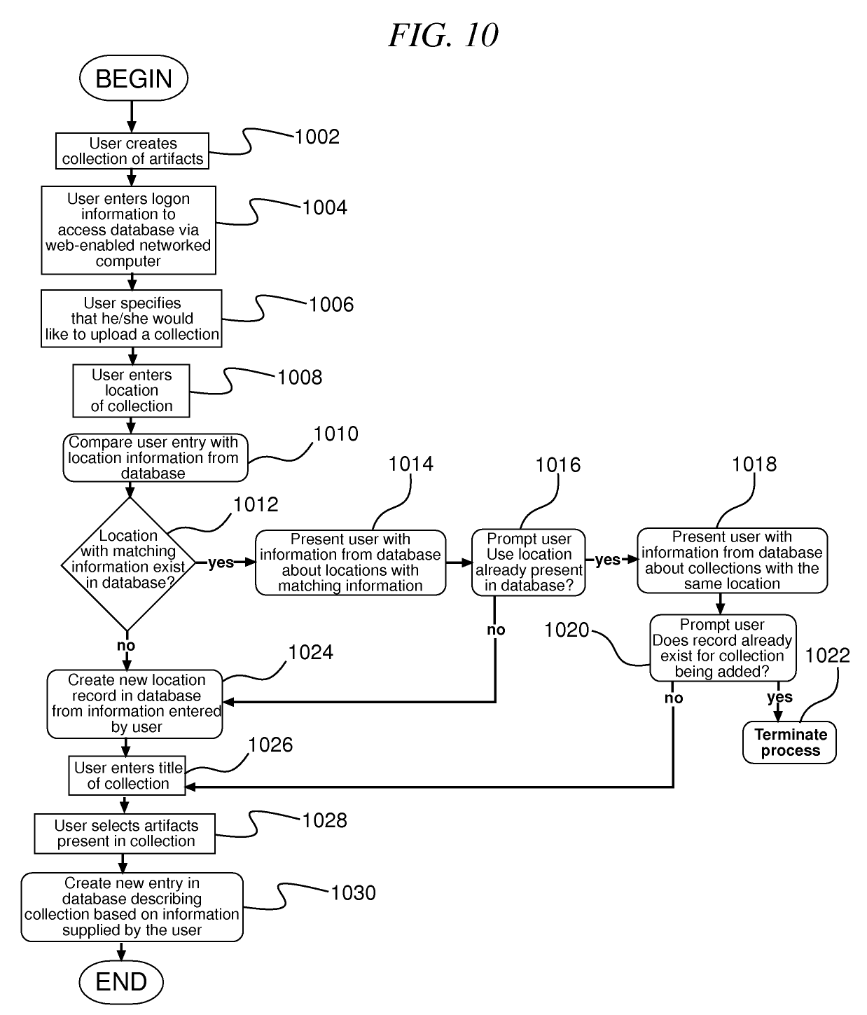

FIG. 10 illustrates the process whereby a use may contribute a collection to the database 138 of the system described herein. Reference is now made to FIG. 10 which shows a simplified flowchart of the process by which collections are uploaded to the database 138 of the invention disclosed herein.

The process of uploading a collection to the system disclosed herein begins with the creation of said collection at 1002. For example in the case of a collection of paintings, a user may decide to gather ten painting by different artists into a coffee shop that he/she owns. The selection of these paintings constitutes the first step in creating the collection.

Next, at 1004 the user enters his/her logon information to access the system disclosed herein via a web-enabled networked computer. At 1006 the user specifies to the system that he/she would like to upload a collection. A central purpose of uploading information regarding a collection is to make said collection accessible to the users of the system disclosed herein. Thus, at 1008 the user who uploads the collection enters into the system the location of said collection. This may be the physical location of the artifacts comprising said collection, or, for instance, in the case of an online collection, this may be the URL (i.e. web-address) of said collection. In the preferred embodiment of the invention disclosed herein, each distinct collection has one distinct entry in the database 138. Additionally, each distinct location has one distinct entry in the database. In order to prevent duplication of location or collection entries in the database, the process illustrated in FIG. 10 proceeds as follows. At 1010 the system compares the location information entered by the user at 1008 to information from location entries in the database 138. If no location entry is found in the database 138 with information that matches the information entered by the user at 1008 then the process proceeds from 1012 to 1024. Alternatively if one or more location entries are found in the database 138 with information that matches the information entered by the user at 1008 then the process proceeds from 1012 to 1014.

At 1014 the system disclosed herein presents the user with information from the database 138 describing location entries identified as matching the location information entered by the user at 1008. Next, at 1016, the user is prompted to declare whether he/she would like to use one of the preexisting location entries presented at 1014 to describe the location of the collection created at 1002. If the user declines to use a location entry already present in the database at 1016 then the process proceeds to 1024. If, on the other hand, the user selects a location entry already present in the database 138 then the process proceeds to 1018. At 1018 the user is presented with information describing collections with preexisting entries in the database 138 that have been associated with the location entry selected at 1016. Next at 1020 the user is prompted to declare whether a record already exists among those presented at 1018 that describes the collection created at 1002. If the user declares that a collection entry does already exist describing the collection created at 1002, then the process terminates at 1022 because there is no need to add an additional entry to the database to describe the same collection. If, alternatively, the user declares at 1020 that there does not exist among the collection entries presented at 1018 an entry that describes the collection created at 1002 then the process proceeds to 1026.

If no location entry exists in the database 138 that matches the location information entered by the user at 1008 then the process proceeds from 1012 to 1024. Alternatively, if the user declines at 1016 to use one of the location entries already present in the database 138 to describe the location of the collection created at 1002 then the process also proceeds to 1024. At 1024 a new location entry is created in the database 138 based on the information entered by the user at 1008. Table 208 of FIG. 2 illustrates an exemplary format for the structure of a location entry in the database 138.

From 1024, or alternatively from 1020, the process continues to 1026. At 1026 the user enters a title for the collection created at 1002. Next, at 1028 the user selects artifacts from the database 138 to be included in the collection. Finally, at 1030, a new entry is created in the database 138 describing the collection created by the user at 1002. Table 206 of FIG. 2 illustrates an exemplary structure for storing such an entry.

Table 206 of FIG. 2 illustrates the inclusion of a “collection id” number in a database entry describing a collection. “Collection id” is a number assigned to each collection entry by the system for internal reference. This is analogous to the “location id” illustrated in Table 208 of FIG. 2 for location database entries and to the “artifact id” illustrated in Table 204 of FIG. 2 for artifact database entries. Table 206 of FIG. 2 also shows a “location id” included in the exemplary structure of a database entry describing a collection. This refers to the “location id” associated with the database entry describing the location of a given collection and indicated by the user at step 1008 or 1016. Next, table 206 of FIG. 2 illustrates the inclusion of a list of “artifacts” in an exemplary database entry describing a collection. This refers to a list of “artifact id” numbers that refer to artifacts that make up said collection. With reference to FIG. 10, the “artifact id” numbers that make up said list of “artifacts” refer to those artifacts identified by the user at step 1028. Finally, table 206 illustrates the inclusion of a “collection rating” number in the exemplary database entry describing a collection. Said “collection rating” is analogous to the data items “artifact rating” and “review rating” described above. This is discussed in further detail below.

It should be noted that although the process illustrated in FIG. 10 does not provide a means for the creator of a collection to include explanations or descriptions of said collection the creator can post such commentary to the system in the form of a review. Nevertheless, in the preferred embodiment of the invention disclosed herein, both collections and reviews are associated with the user who created them. This allows for a review posted by the creator of a given collection to be preferentially presented to a user viewing information regarding said collection. In this manner, the creator of a collection can include explanations or descriptions of said collection, despite the fact that this is not explicitly included in the process illustrated in FIG. 10.

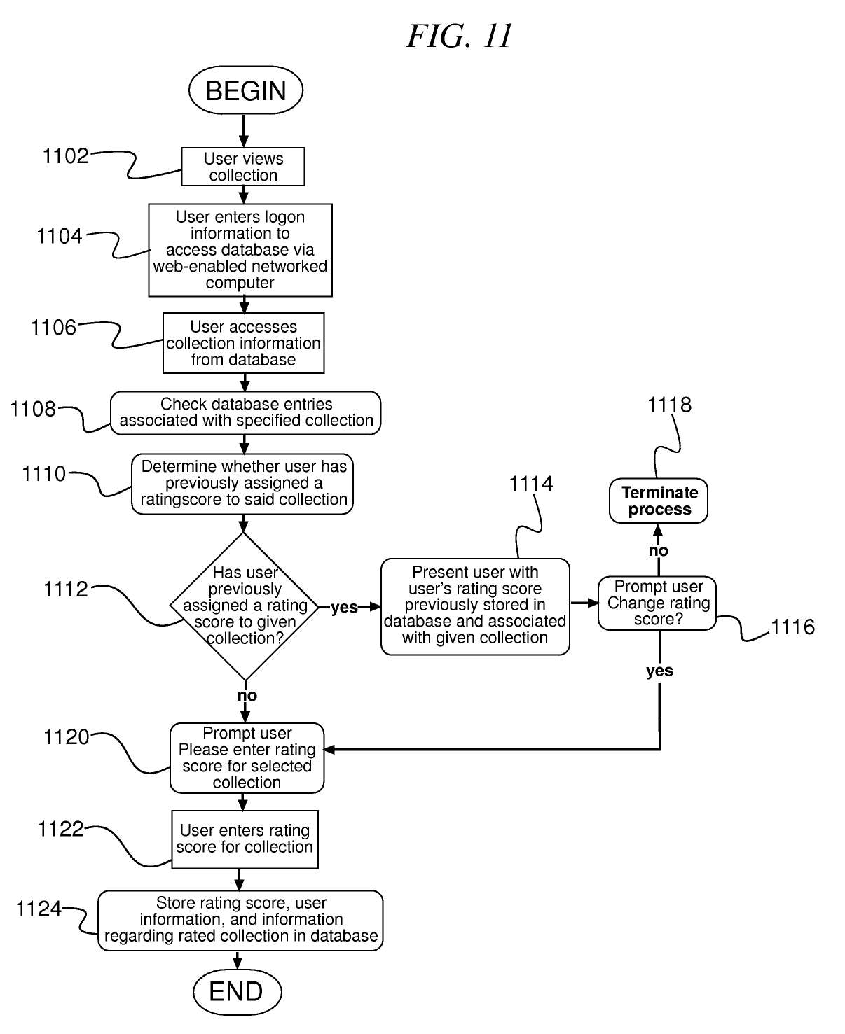

In a manner similar to the process of rating artifacts illustrated in FIG. 4 and the process of rating reviews illustrated in FIG. 8, users may rate collections. The process by which a user may rate a collection is illustrated in FIG. 11. Reference is now made to FIG. 11 which shows a simplified flowchart of the process by which users supply rating scores to collections which they have accessed. The rating process begins when a user accesses a collection so that he/she may develop an opinion of said collection. At 1102 a collection is accessed by a typical user of the system described herein. In the case where the accessed collection is a series of paintings on display in a coffee shop, for instance, accessing the collection may entail viewing said paintings by visiting said coffee shop.

Next, at 1104 the user who has viewed a collection at 1102 accesses the system disclosed herein by entering his/her logon information via a web-enabled networked computer. At 1106 the user identifies the database entry for the collection viewed at 1102. This process of identification may involve, for instance, the user performing a search of the database 138 by entering the title of the collection.

In order to promote the fairness of the evaluation scheme described herein, each user may contribute only one rating to the overall rating score of each collection. Thus it is necessary to associate a user name with each rating score. The method for storing collection rating scores is illustrated in table 212 of FIG. 2, which shows an exemplary structure for a database entry describing an individual collection rating. At 1108 the system retrieves entries from the database associated with the collection identified by the user at 1106. At 1110 the system then determines whether the user has previously assigned a rating score to said collection. If the user has not previously entered a rating score for the specified collection then the process proceeds to 1120. If the user has previously entered a rating score for the specified collection then the process proceeds to 1114. At 1114 the user is presented with the rating score previously stored in the database 138 and associated with said user (who has entered logon information at 1104) and said selected collection (identified at 1106). Then, at 1116 the user is prompted to declare whether he/she would like to change the rating score from that presented at 1114. If the user declines to change said rating score then the process terminates at 1118. If the user elects to change said rating score then the process proceeds to 1120.

At 1120 the user is prompted by the system to enter a rating score for the collection identified at 1106. At 1122 the user enters a new rating score for said collection. In the preferred embodiment of the invention said rating score may be a number between 1 and 10. At 1124 said new rating score is stored in the database along with information describing the collection and information describing the user. Table 212 shows a preferred format for storing this information as a “collection rating” entry in database 138.

It is anticipated that a large number of users will use the system disclosed herein. Thus it is further anticipated that a large number of collections may be uploaded to the system. This creates the need for organizing collections based on a criterion or indicator of quality. In order to organize collections, and to preferentially present collections that meet certain criteria, a means is provided whereby collections are rated by users of the system. This is similar to the scheme provided for the rating of artifacts (illustrated in FIG. 4 and FIG. 5) and for the rating of reviews (illustrated in FIG. 8 and FIG. 9).

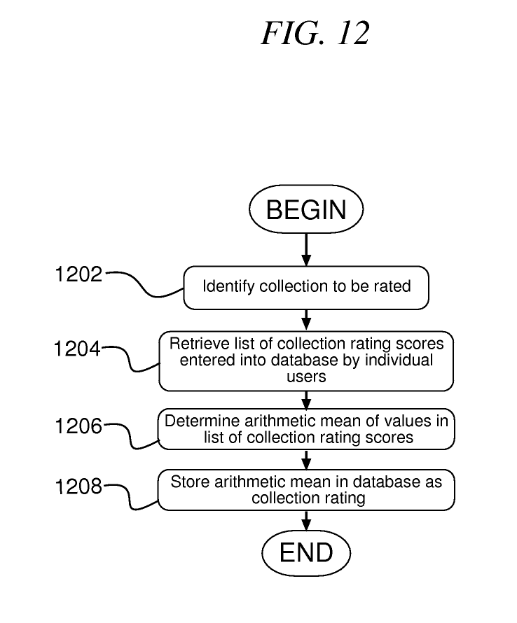

Reference is now made to FIG. 12 which shows a simplified flowchart of the process by which collection ratings (illustrated in table 206 of FIG. 2) are calculated from collection rating scores (illustrated in table 212 of FIG. 2). At 1202 the system of the invention disclosed herein identifies a collection for which the collection rating should be updated. In the preferred embodiment of the invention this is achieved by updating the collection rating of a given collection automatically after a user has changed or added a collection rating score for said collection. In such a configuration the process illustrated in FIG. 12 is triggered by the completion of the process illustrated in FIG. 11 if said latter process involves the addition or change of a collection rating score (i.e. termination of the process illustrated in FIG. 11 after step 1124). Alternate schemes for determining a collection rating update schedule are possible though. Such alternate schemes may include periodic updating of all collection ratings or updating of a given collection rating only after a specified number of individual collection rating scores have been changed. These alternate schemes do not change the spirit of the invention and are considered ramifications.

After a collection has been identified at 1202 as a candidate for the updating process illustrated in FIG. 12, the process proceeds to 1204. At 1204 a list of collection rating scores associated with said collection identified at 1202 is created based on collection rating entries (illustrated as table 212 of FIG. 2) stored in database 138. The list of collection rating scores created at 1204 is comprised of all of the collection rating scores associated with a given collection. Each item in said list furthermore represents the opinion of a single user and each item represents the opinion of a different user. This is ensured by the process illustrated in FIG. 11, which allows for each user of the system described herein to supply only a single collection rating score for each collection.

Next, at 1206 the arithmetic mean of the user supplied collection rating scores aggregated in the list created at 1204 is calculated. In the preferred embodiment of the invention collection ratings are calculated by determining the arithmetic mean of all user supplied collection rating scores for said collection. Alternate schemes are possible and constitute ramifications of the invention disclosed herein. For example, collection ratings may be calculated by determining a weighted average of user supplied collection rating scores in which the collection ratings scores supplied by some users are more or less highly weighted than others.

Finally, at 1208 the arithmetic mean of the user supplied collection rating scores aggregated in the list created at 1204 is stored in the database 138. Said arithmetic mean is stored under the heading of “collection rating” as illustrated in table 206 of FIG. 2.

### User Ratings

For many individuals an important part of engaging in an activity is receiving recognition for one's work. Many artists for example are unable to financially support themselves entirely through their art. Nevertheless the hope of receiving recognition prevails. The invention disclosed herein includes a means for aggregating the various ratings assigned to artifacts, reviews, and collections produced by a given user into a three aggregate scores—a “user artifact rating”, a “user collection rating”, and a “user review rating”. A user of the system disclosed herein can thus have an indicator of the recognition he/she has received for his/her efforts at producing artifacts, writing review, or arranging collections. It is an aim of the system disclosed herein to provide a means by which individuals may become recognized for their work without having to rely on other traditional forms of exhibition. Thus, for instance, even an artist who is not represented by a talent agent and who's work is not represented by art galleries or shown in museums can become recognized for his/her talent by a wide audience of users.

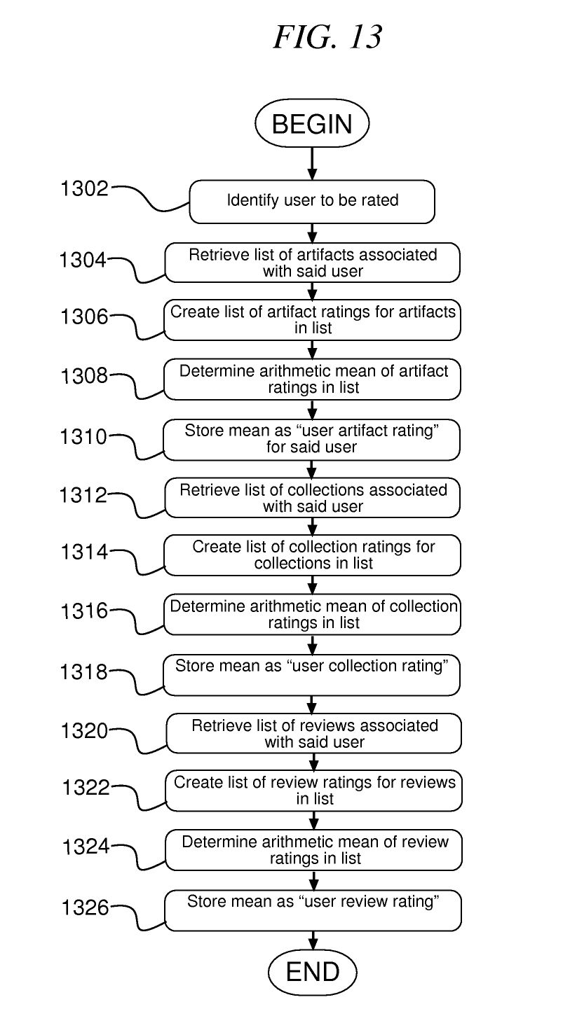

Table 202 of FIG. 2 shows a means for storing the three metrics of recognition mentioned above—i.e. “user artifact rating”, “user collection rating”, and “user review rating”. The preferred embodiment of the invention disclosed herein includes three distinct user rating scores. Each rating score represents the recognition gained by a given user in one of three categories: the production of artifacts, the production of reviews, and the production of collections. Reference is now made to FIG. 13, which shows a simplified flowchart of the process by which the three user ratings listed above are calculated.

First, at 1302 the user to be rated is identified. In the preferred embodiment of the invention described herein user ratings are updated for a given user each time a change is made to an “artifact rating” (see FIG. 5), “review rating” (see FIG. 9), or “collection rating” (see FIG. 12), for an artifact, collection, or review for which said user is listed as the author. A user is listed as the author of an artifact, review, or collection if the user id of said user appears under the heading “user id (author)” for said artifact, review, or collection. Alternative schemes are possible for determining the update schedule for user ratings. For instance user ratings may be periodically updated for all users of the system. Such alternate schemes are considered ramifications and do not alter the spirit of the invention.

Next, at 1304, a list of artifacts associated with the user identified at 1302 is retrieved from the database 138. Said list of artifacts is comprised of those artifacts for which the entries stored in the database 138 (see Table 204 of FIG. 2) list the “user id” of said user under the heading “user id (author)”. At 1306 the “artifact rating” of each artifact in said list is added to a list of artifact ratings. In the preferred embodiment of the invention disclosed herein, “user artifact rating” scores are calculated by determining the arithmetic mean of all of the “artifact rating” scores of artifacts authored by a given user. Thus, at 1308 the arithmetic mean of the “artifact rating” scores in the list created at 1306 is determined. Alternative methods for determining a “user artifact rating” score are possible. For instance, a weighted average of individual “artifact rating” scores may be used, in which “artifact rating” scores that represent the individual ratings of a greater number of users contribute more significantly to the “user artifact rating”. Such alternative methods for determining a “user artifact rating” are considered ramifications and do not affect the spirit of the invention disclosed herein. At 1310, the value determined at 1308 is stored as the “user artifact rating” score for the user identified at 1302. Table 202 of FIG. 2 shows an exemplary structure for storing user information in a database and illustrates the inclusion of a data item marked “user artifact rating”.

Once the “user artifact rating” has been determined and stored as described above, the process illustrated in FIG. 13 proceeds to a determination and storing of a “user collection rating”. At 1312, a list of collections associated with the user identified at 1302 is retrieved from the database 138. Said list of collections is comprised of those collections for which the entries stored in the database 138 (see Table 206 of FIG. 2) list the “user id” of said user under the heading “user id (author)”. At 1314 the “collection rating” of each collection in said list is added to a list of collection ratings. In the preferred embodiment of the invention disclosed herein, “user collection rating” scores are calculated by determining the arithmetic mean of all of the “collection rating” scores of collections authored by a given user. Thus, at 1316 the arithmetic mean of the “collection rating” scores in the list created at 1314 is determined. Alternative methods for determining a “user collection rating” score are possible. For instance, a weighted average of individual “collection rating” scores may be used, in which “collection rating” scores that represent the individual ratings of a greater number of users contribute more significantly to the “user collection rating”. Such alternative methods for determining a “user collection rating” are considered ramifications and do not affect the spirit of the invention disclosed herein. At 1318, the value determined at 1316 is stored as the “user collection rating” score for the user identified at 1302. Table 202 of FIG. 2 shows an exemplary structure for storing user information in a database and illustrates the inclusion of a data item marked “user collection rating”.

Next, once both the “user artifact rating” and “user collection rating” have been determined and stored as described above, the process illustrated in FIG. 13 proceeds to a determination and storing of a “user review rating”. At 1320, a list of reviews associated with the user identified at 1302 is retrieved from the database 138. Said list of reviews is comprised of those reviews for which the entries stored in the database 138 (see Table 214 of FIG. 2) list the “user id” of said user under the heading “user id (author)”. At 1322 the “review rating” of each review in said list is added to a list of review ratings. In the preferred embodiment of the invention disclosed herein, “user review rating” scores are calculated by determining the arithmetic mean of all of the “review rating” scores of reviews authored by a given user. Thus, at 1324 the arithmetic mean of the “review rating” scores in the list created at 1322 is determined. Alternative methods for determining a “user review rating” score are possible. For instance, a weighted average of individual “review rating” scores may be used, in which “review rating” scores that represent the individual ratings of a greater number of users contribute more significantly to the “user review rating”. Such alternative methods for determining a “user review rating” are considered ramifications and do not affect the spirit of the invention disclosed herein. At 1326, the value determined at 1324 is stored as the “user review rating” score for the user identified at 1302. Table 202 of FIG. 2 shows an exemplary structure for storing user information in a database and illustrates the inclusion of a data item marked “user review rating”.

1. In a computer system including a server computer and a database comprised of entries describing users and artifacts, a method for presenting a first user with information regarding one or more of said artifacts said information comprising the location or locations of said one or more artifacts as well as one or more of a) the times during which said user may access said one or more artifacts b) descriptive information regarding said one or more artifacts; said method further comprising a means whereby a second user may add to said database one or more entries, each of said one or more entries describing a unique artifact; said method further comprising a means whereby a user may manipulate information associated with said user in said database.
Whereby a method is established whereby a user may acquire information provided by other users regarding the accessibility of artifacts of potential interest as well as information regarding said other users.

2. The method of claim 1 wherein each said unique artifact is the property of a user of said computer system.

3. The method of claim 1 further comprising a means by which each of said users may assign a rating score to each of said artifacts.

4. The method of claim 3 further comprising a means by which a multiplicity of said rating scores assigned to a given artifact may be combined to form a single rating score.

5. The method of claim 4 wherein said rating scores are numerical scores and said single rating score is calculated for a given artifact by determining the arithmetic mean of said rating scores associated with said given artifact.

6. The method of claim 1 wherein said database is further comprised of entries describing collections, and wherein each of said collections is a grouping of one or more artifacts.

7. The method of claim 6 wherein each of said collections refers to a grouping of one or more artifacts housed at the same location.

8. The method of claim 6 further comprising a means by which each of said users may assign a rating score to each of said collections.

9. The method of claim 8 further comprising a means by which a multiplicity of said rating scores assigned to a given collection by a multiplicity of users may be combined to form a single score.

10. The method of claim 9 wherein said rating scores are numerical scores and said single score is calculated for a given collection by determining the arithmetic mean of said rating scores associated with said given collection.

11. The method of claim 1 further comprising a means wherein each of said artifacts may be associated with one of said users.

12. The method of claim 11 wherein an artifact is associated with the user who has added to said database a unique entry describing said artifact.

13. The method of claim 11 further comprising a means by which each of said users may assign an artifact rating score to each of said artifacts.

14. The method of claim 13 further comprising a means by which a given user may be assigned a user artifact rating score, said user artifact rating score determined by combining, according to a predetermined algorithm, rating scores associated with those artifacts associated with said given user.

15. The method of claim 6 wherein each of said collections is associated with one of said users.

16. The method of claim 15 wherein a collection is associated with the user who has added to said database the entry describing said collection.

17. The method of claim 15 further comprising a means by which each of said users may assign a rating score to each of said collections.

18. The method of claim 17 further comprising a means by which a given user may be assigned a user collection rating score, said user rating score determined by combining, according to a predetermined algorithm, those rating scores associated with the collections associated with said given user.

19. The method of claim 1 further comprising a means by which additional information may be added to said database wherein said additional information makes reference to one or more unique artifacts for which one or more entries already exist in said database, and wherein said additional information may be added by a user other than the one or more users who previously added to said database the one or more entries describing said one or more artifacts.

20. The method of claim 19 wherein said additional information is further associated in said database with the user who has added said additional information to said database.

21. The method of claim 20 further comprising a means by which each of said users may associate a rating score to said additional information.

22. The method of claim 21 further comprising a means by which a given user may be assigned a user review rating score, said user review rating score determined by combining, according to a predetermined algorithm, those rating scores associated with the additional information associated with said given user.

23. The method of claim 1 further comprising a means by which a user may perform a search of said database according to one or more criteria.

24. The method of claim 23 wherein said search may be performed according to one or more criteria selected from the group comprising: artifact location, descriptive information, and times during which a given artifact is accessible.
